(19) United States
(12) Patent Application Publication
(10) Pub. No.: US 2023/0282082 A1
(43) Pub. Date: Sep. 7, 2023

(54) Cable for Anti-Theft Protection, Electric Charging and Data Communication for Two-Wheeled Electric Vehicles

(71) Applicant: EVOLVO S.R.L., Torino (IT)

(72) Inventor: Igor TEMPO, Torino (IT)

(21) Appl. No.: 18/015,367

(22) PCT Filed: Feb. 24, 2021
(86) PCT No.: PCT/IT2021/050042

§ 371 Date: Jan. 10, 2023

(30) Foreign Application Priority Data
Jul. 10, 2020 (IT) 102020000016774

(51) Int. Cl. G08B 13/12; G08B 13/14; B60L 53/18; B62H 5/20

(52) U.S. Cl. CPC G08B 13/12; G08B 13/1409; B60L 53/18; B62H 5/20; B60L 2200/12; B60L 2270/36

(57) ABSTRACT

A cable (1) for anti-theft protection, electric charging and data communication for two-wheeled electric vehicles is described, comprising: an external containment sheath (13); a spiral armor (11) designed to ensure anti-theft mechanical seal; a sheath (9) contained in the spiral armor (11); and a group (7) of conductors (3) each wrapped in an insulating element (5), this group (7) being contained in the sheath (9), each of the conductors (3) with or without connectors at its ends being designed to perform one of the following functions: electrical connection for charging a vehicle; communication link between a vehicle and another vehicle or between a vehicle and external control and management means; and alarm/anti-theft function in case of its shearing.

The present invention refers to a cable for anti-theft protection, electric charging and data communication for two-wheeled electric vehicles, in particular for pedal assisted bicycles, scooters or motorcycles.

For this type of two-wheeled vehicles, there are currently no solutions that allow the creation of multiple functions such as anti-theft, electric charging and data communication with the outside, which allow the electric charging of the vehicle to be carried out safely in a managed way.

Object of the present invention is solving the aforementioned prior art problems by providing a cable for anti-theft protection, electric charging and data communication for electric two-wheeled vehicles which allows to perform the following functions together:
ensure an electrical connection for charging the vehicle;
guarantee a connection for communication between the control unit on board the vehicle and the column of an external management and control system, or with the control unit itself, in autonomous anti-theft mode;
allow the alarm/anti-theft function via a guard wire; and
guarantee a mechanical anti-theft seal, of the metal chain type, by means of ropes present in the structure.

The above and other objects and advantages of the invention, as will emerge from the following description, are achieved with a cable for anti-theft protection, electric charging and data communication for two-wheeled electric vehicles such as that described in claim 1. Preferred embodiments and non-trivial variants of the present invention form the subject of the dependent claims.

It is understood that all attached claims form an integral part of the present description.

It will be immediately obvious that innumerable variations and modifications (for example relating to shape, dimensions, arrangements and parts with equivalent functionality) can be made to what is described without departing from the scope of the invention as appears from the attached claims.

The present invention will be better described by some preferred embodiments, provided by way of non-limiting example, with reference to the attached drawings, in which:

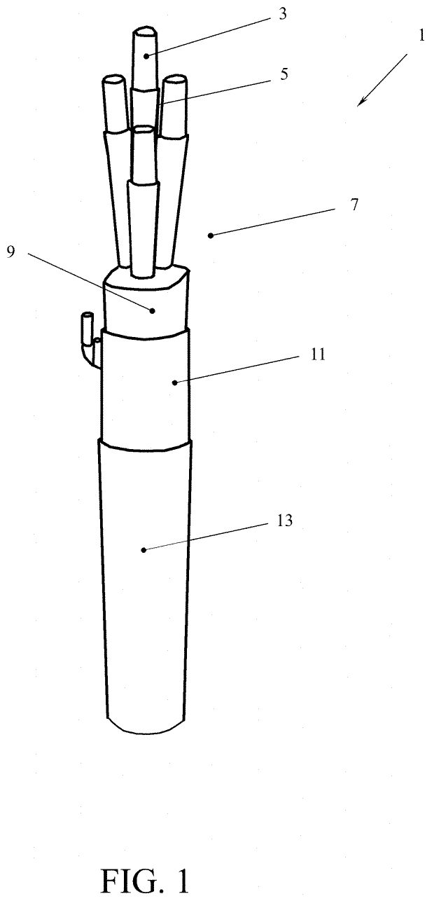

FIG. 1 illustrates a cut-away front view of a preferred embodiment of the cable of the present invention; and

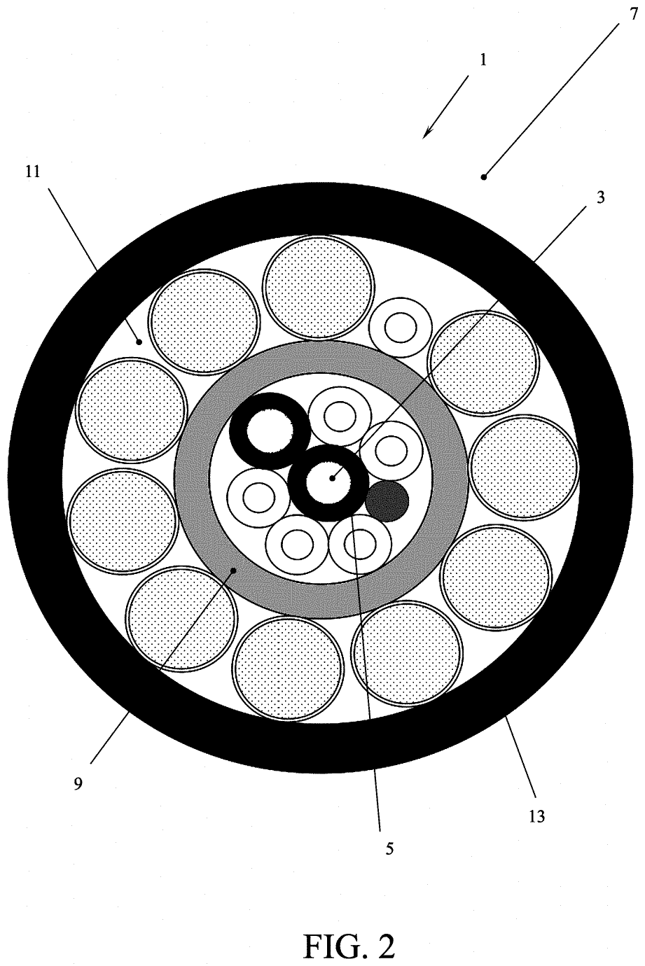

FIG. 2 illustrates a cross-sectional view of the cable of FIG. 1.

With reference to the Figures, the cable 1 for anti-theft protection, electric charging and data communication for electric two-wheeled vehicles of the present invention substantially comprises:
an external containment sheath 13;
a spiral armor 11 contained in the outer sheath 13 and designed to ensure anti-theft mechanical seal;
a sheath 9 contained in the spiral armor 11; and
a group 7 of conductors 3 each wrapped in an insulating element 5, in which the group 7 is contained in the sheath 9, each of the conductors 3 being designed to perform one of the following functions (and the assembly of conductors 3 performing all the functions listed below):
electrical connection for charging a vehicle;
communication link between a vehicle and external control and management means (not shown); and
alarm/anti-theft function in case of its blanking.

In particular, the outer sheath 13 can be made of polyurethane.

Preferably, the spiral armor 11 comprises insulated galvanized steel cables.

Again in particular, the sheath 9 can be made of PVC.

As illustrated, the unit 7 is made as a composite joining of the conductors 3, so as to hold them integrally together.

Preferably, the insulating element 5 can be made of PVC type R2, while the conductors 3 can be made of flexible cord, preferably of annealed electrolytic red copper.

By way of example and not limiting, two-wheeled vehicles can be bicycles, scooters and motorcycles, but obviously the cable 1 of the invention can also be used for other types of vehicles with one, three or four wheels, which require the functions provided by the 1 cable itself.

The structure of the cable 1 described above is completed by the connectors 3 which can be found on one or both sides of the cable 1, constituting a real control, communication and anti-theft system in a single object.

The main technical characteristics of the cable 1 of the present invention are as follows.

The power supply and control cable 1 is armored, does not propagate fires, has a reduced emission of toxic/corrosive gases and opaque fumes in the event of a fire, is suitable for use in civil/industrial environments, in fixed laying even directly underground and unprotected. The armor guarantees optimal mechanical protection even in heavy-duty applications.

| CABLE FEATURES | REFERENCE STANDARDS |
|---|---|
| Construction | CEI EN 60228-Conductor of |
| | insulated cables |
| Emission of opaque fumes | IEC 60754-1-Test on gases |
| and toxic/corrosive | evolved during combustion- |
| gases | Part 1: Determination of the |
| | halogen acid gas content |
| Construction | IEC 60227 a.f.a.a.-PVC |
| | insulated cables with rated |
| | voltage up to 450/750 V |
| UE Directives | Directive 2014/35/EU-Low |
| | voltage |
| UE Directives | Directive RoHS 2011/65/EU- |
| | Restriction of hazardous |
| | substances |

The cable 1 can also be made with tinned copper conductors.

The conductors 3 are preferably in annealed electrolytic red copper CU-ETP (DIN 5787—Cu>99.9%, O2<0.04%) and flexible rope in accordance with CEI EN 60228 cl. 5

The insulation 5 is preferably PVC type R2 in accordance with CEI EN 50363-0.

The armor 11 is made of spiral galvanized steel cables—∅=3 mm+XLPE insulation

The nominal voltage of cable 1 is 300/500 V.

The test voltage is 2000 V AC for 5 minutes in acc. to IEC 60227.

The operating temperature is −40/+70° C. in fixed laying.

The maximum short circuit temperature is 160° C.

The insulation resistance is >100 MOhm×km.

The minimum bending radius is 10 times the outer diameter of the cable.

The main measurements of cable 1 are shown in the following table.

| | | | | | Diameter | | |
|---|---|---|---|---|---|---|---|
| | | | | | under | External | |
| | | | Copper | Cable | armor | diameter | Res. max |
| | | | weight | weight | (mm, | (mm, | in c.c. at |
| | | | (approx. ) | (approx. ) | +/− | +/− | 20° C. |
| N. | FTC Code | Cable type | (kg/m) | (kg/m) | 10%) | 10%) | (Ω/km) |
| 1 | BEDACAX001233 | FR2ORFQ COCL | 0.042 | 0.899 | 8.4 | 17.8 | 19.5/39.0 |
| | | 300/500 V 2 × 1 + | | | | | |
| | | 5 × 0, 5 + 1 × 0, 5 | | | | | |

1. A cable for anti-theft protection, electric recharge and data communication for two-wheeled electric vehicles, comprising:
an external containing sheath;
a spiral armor contained in the external sheath for a mechanical anti-theft protection;
an inner sheath contained in the spiral armor; and
an assembly of conductors, each one conductor wound in an insulating element, said assembly being contained in said small inner sheath;
wherein at least one of the conductors is an electrical conductor which provides electrical charging connection for the two-wheeled electric vehicle, at least one of the conductors is a communication conductor which provides communication connection for the two-wheeled vehicle, and at least one of the conductors is an anti-theft cable configured to communicate with an anti-theft alarm if the anti-theft cable is cut.

2. The cable according to claim 1, characterized in that said external sheath is made of polyurethane.

3. The cable according to claim 1, characterized in that said spiral armor comprises insulated ropes made of zinc-coated steel.

4. The cable according to claim 1, characterized in that said inner small sheath is made of PVC.

5. The cable according to claim 1, characterized in that said assembly is made as composite union of said conductors).

6. The cable according to claim 1, characterized in that said insulating element is made of PVC type R2.

7. The cable according to claim 1, characterized in that said conductors are made of flexible rope.

8. The cable according to claim 1, characterized in that the two-wheeled vehicles are bicycles, scooters, or motorcycles.

9. The cable of claim 7 wherein the flexible ropes comprise annealed electrolytic red copper.

10. The cable of claim 7 wherein the flexible ropes comprise tinned copper conductors.

11. The cable of claim 1 wherein the spiral armor comprises insulated galvanized steel cables.

12. The cable of claim 1 having a minimum bending radius 10 times the outer diameter of the cable.
